(19) United States
(12) Patent Application Publication
(10) Pub. No.: US 2024/0362879 A1
(43) Pub. Date: Oct. 31, 2024

(54) Anchor Objects for Artificial Reality Environments

(71) Applicant: Meta Platforms Technologies, LLC, Menlo Park, CA (US)

(72) Inventors: David Frederick GEISERT, London (GB); Lauren JAVOR, Seattle, WA (US); Paul Armistead HOOVER, Bothell, WA (US)

(21) Appl. No.: 18/645,825

(22) Filed: Apr. 25, 2024

Related U.S. Application Data
(60) Provisional application No. 63/498,781, filed on Apr. 27, 2023.

(51) Int. Cl. G06T 19/20; G06F 3/01; G06T 19/00

(52) U.S. Cl. CPC G06T 19/20; G06F 3/011; G06T 19/006; G06T 2219/2004

(57) ABSTRACT

Aspects of the present disclosure relate to an anchor object to which virtual objects can be consistently mapped in an artificial reality (XR) environment. In some implementations, the virtual objects can include avatars of users accessing the XR environment on respective XR systems. The anchor object can be a virtual object, such as a menu or shape, or a physical object, such as a stage computing device positioned in the users' surrounding real-world environments. The users can move the anchor object as rendered on their respective XR systems, which causes reciprocal movement of their corresponding avatars on other users' XR systems. Thus, virtual objects can be consistently referenced across all of the XR systems accessing the XR environment.

### CROSS-REFERENCE TO RELATED APPLICATIONS

This application claims priority to U.S. Provisional Patent Application No. 63/498,781, filed Apr. 27, 2023, entitled “Object Reference Frames in Augmented Reality Experiences,” which is herein incorporated by reference in its entirety.

### TECHNICAL FIELD

The present disclosure is directed to an anchor object from which virtual objects can be consistently mapped in an artificial reality (XR) environment.

### BACKGROUND

Artificial reality (XR) devices are becoming more prevalent. As they become more popular, the applications implemented on such devices are becoming more sophisticated. Mixed reality (MR) and augmented reality (AR) applications can provide interactive three-dimensional (3D) experiences that combine images of the real-world with virtual objects, while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. AR, MR, and VR (together XR) experiences can be observed by a user through a head-mounted display (HMD), such as glasses or a headset. An HMD can have a pass-through display, which allows light from the real-world to pass through a lens to combine with light from a waveguide that simultaneously emits light from a projector in the HMD, allowing the HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for anchoring virtual objects to an anchor object in an artificial reality environment.

FIG. 6A is a conceptual diagram illustrating an example view on an artificial reality (XR) system of a virtual anchor object that can be used to provide spatial consistency for multiple users in a shared XR environment.

FIGS. 6B and 6C are conceptual diagrams illustrating example views from an XR device of a user when the user moves toward an anchor object.

FIG. 7 is a conceptual diagram illustrating example positionings of avatars around an anchor object.

FIGS. 8A and 8B are conceptual diagrams illustrating views of dynamic anchor objects that can launch and execute applications.

FIGS. 9A and 9B are conceptual diagrams illustrating views of spatial distance positioning between two avatars in an XR environment.

FIGS. 10A and 10B are conceptual diagrams illustrating views of spatial height positioning between two avatars in an XR environment.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure relate to an anchor object to which virtual objects can be consistently mapped in an artificial reality (XR) environment. In some implementations, the virtual objects can include avatars of users accessing the XR environment on respective XR systems. The anchor object can be a virtual object, such as a menu or shape, or a physical object, such as an inert physical device tracked by an XR system or a stage device (e.g., device 254 discussed below) positioned in the users' surrounding real-world environment. A user can move the anchor object, as rendered or shown on their XR system, which can cause the virtual objects surrounding the user to reposition to maintain their respective positions and poses relative to the anchor object. Such movement of the anchor object by the user can cause reciprocal movement of the user's corresponding avatar as rendered on other users' XR systems. In some implementations, movement of the anchor object is not rendered by the other users' XR systems. Thus, virtual objects can be consistently referenced across all of the XR systems accessing the XR environment.

For example, a first user can access an artificial reality (XR) birthday experience on a first XR device, in which virtual decorations and virtual gifts are overlaid on a view of a real-world home surrounding the first user. A virtual anchor object (e.g., an application menu) can be rendered in front of, and within arm's reach of, the first user. A second user can join the XR birthday experience on a respective second XR device to share in the celebration, and can be rendered as an avatar on the first user's XR device. The first user, sitting on the couch, may be unable to reach a virtual gift rendered on a physical table in front of the anchor object. Thus, the first user can reach forward, grab the anchor object, and bring it closer, e.g., by 0.5 meters and rotating it. Correspondingly, as rendered on the first user's XR device, the virtual gift (and other virtual decorations and objects) is moved toward the first user and by the same rotational amount. The first user can then grab the virtual gift, now within reach, and unwrap it.

Conversely, as rendered on the second user's XR device, the anchor object, in some cases, may not move. Instead, the first user's avatar is moved, from the perspective of the second user, relative to the anchor object by a corresponding amount (e.g., toward the anchor object 0.5 meters and rotationally). The first user's avatar is then rendered grabbing and unwrapping the virtual gift from this closer location. On the first user's XR device, the first user can then point to a virtual cake 90 degrees directly to the left, which has been moved forward 0.5 meters due to the movement of the anchor object. Although the anchor object has not been moved on the second user's XR device, the position of the first user's avatar has been moved forward 0.5 meters. Thus, on the second user's XR device, the first user's avatar is still seen pointing to the virtual cake 90 degrees directly to the left of the first user's avatar.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The implementations described herein provide specific technological improvements in the field of artificial reality. Certain technical challenges exist for managing applications and virtual objects in XR environments, as well as seamlessly presenting XR experiences to users. Some implementations described herein address this challenge and others by utilizing an anchor object that, in some implementations, can present and launch XR applications. In a multiuser XR environment, some implementations can allow multiple users to immerse themselves within the XR experience by handling the relative positioning of virtual objects and avatars in the shared XR environment. Further, some implementations can allow the user to move the anchor object (sometimes in six degrees of freedom, sometimes only in one plane—e.g., horizontally to the ground, sometimes only rotationally in one or more planes, or combinations thereof) to correspondingly move the positioning of virtual objects and avatars in the shared XR environment.

The anchor object management system described herein improves on existing XR techniques by having both users' XR head-mounted displays (HMDs) share mapping information relative to a spatial anchor/control element with each other, so each HMD (and thus, each user) would know where they are relative to each other, and relative to the anchor object. By sharing this mapping information with each other, the anchor object may be used to orient each HMD and user with respect to a common central anchor among all users' XR environments, and additionally orient each HMD and user with respect to each other even when the users are not co-located in the same real-world environment. For example, if two users (each wearing head HMDs) are in a shared XR environment, then both headsets will be localized with respect to a common anchor.

In addition, some implementations described herein improve upon existing XR experience rendering techniques in that they allow users having large physical spaces to not have to move about their extensive real-world environment while using the XR device to interact with out-of-reach virtual objects. Thus, some implementations described herein take into account the differences of different users' real-world environments in order to provide a fair and accessible experience. Otherwise, various problems will be present, such as users with smaller physical spaces having an advantage over users in large physical spaces, and/or users with limited ability or mobility being unable to engage virtual objects that are otherwise out-of-reach.

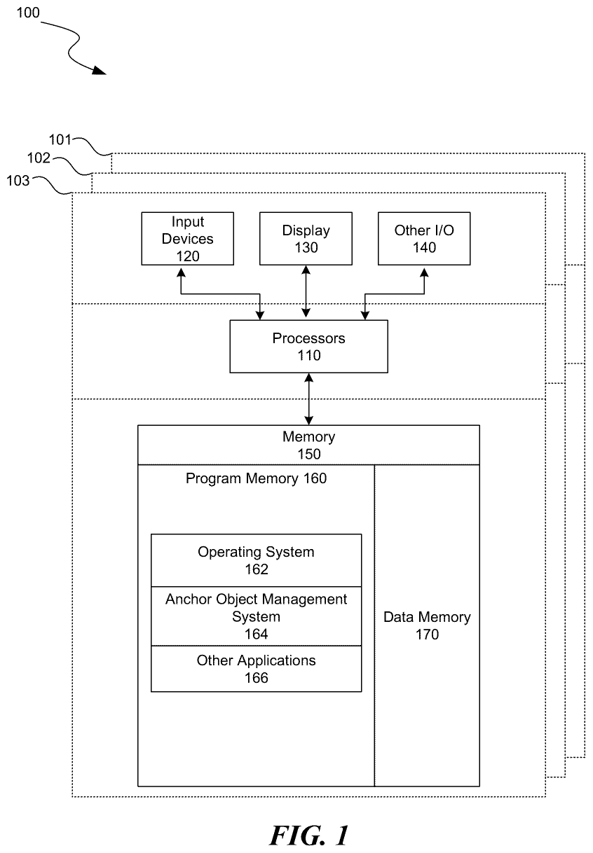

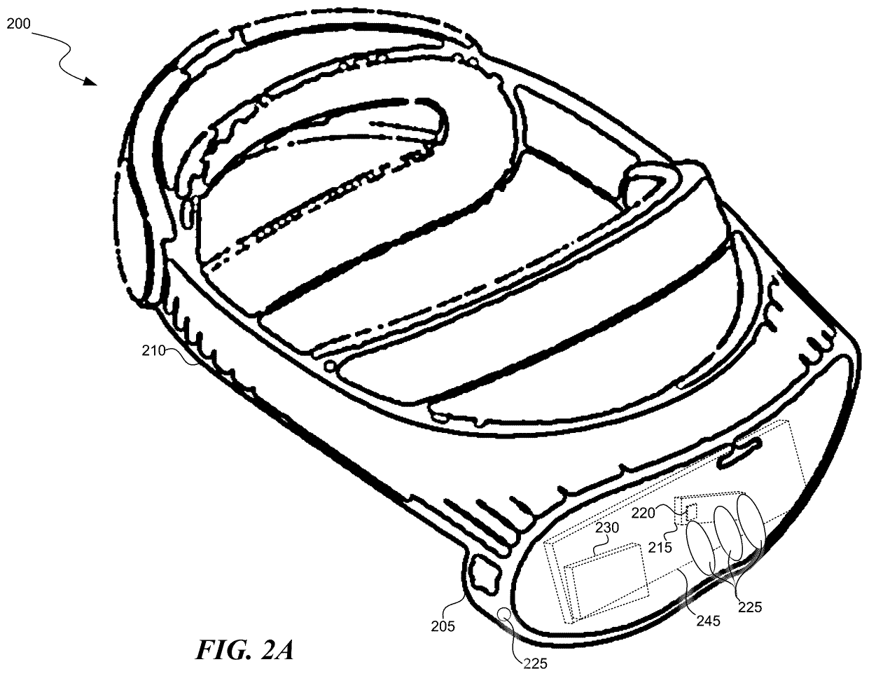

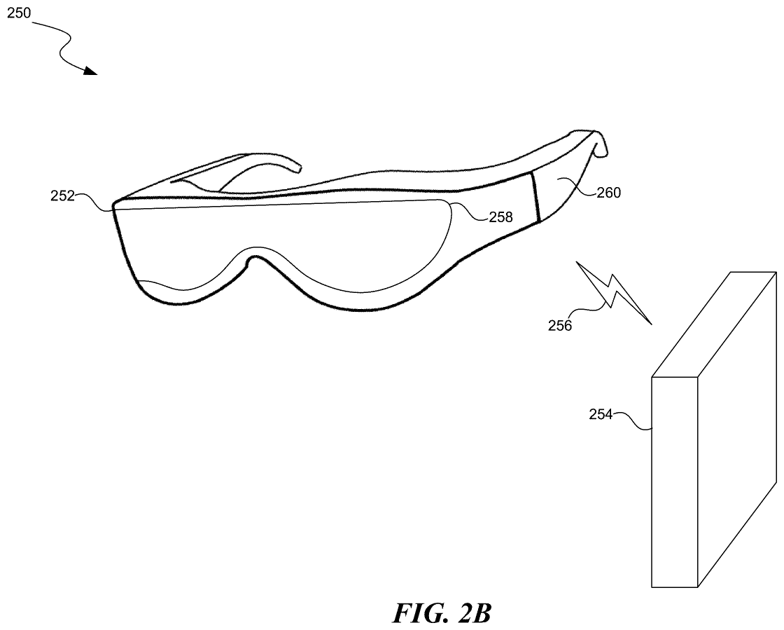

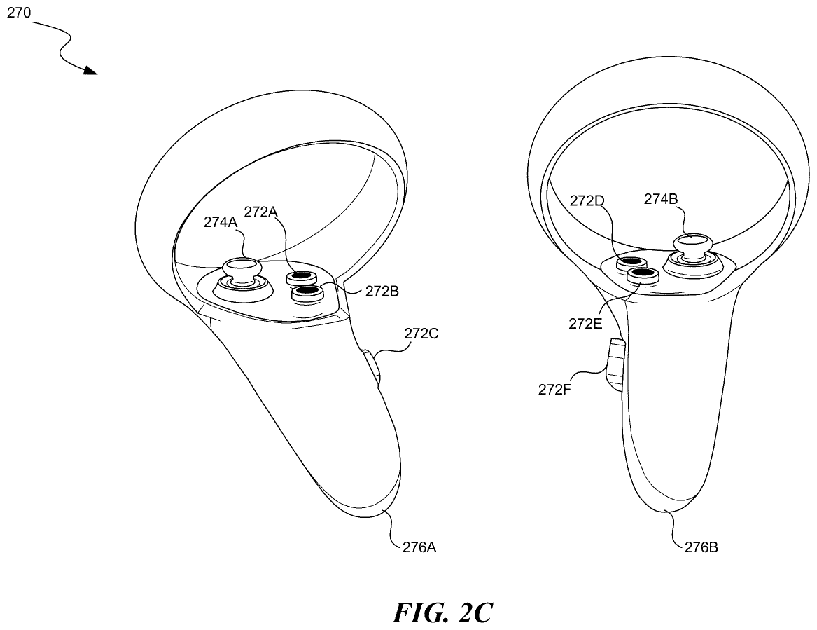

Several implementations are discussed below in more detail in reference to the figures. FIG. 1 is a block diagram illustrating an overview of devices on which some implementations of the disclosed technology can operate. The devices can comprise hardware components of a computing system 100 that can anchor virtual objects to an anchor object in an artificial reality (XR) environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, anchor object management system 164, and other application programs 166. Memory 150 can also include data memory 170 that can include, e.g., rendering data, anchor object data, position data, pose data, virtual object data, avatar data, movement data and other input data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

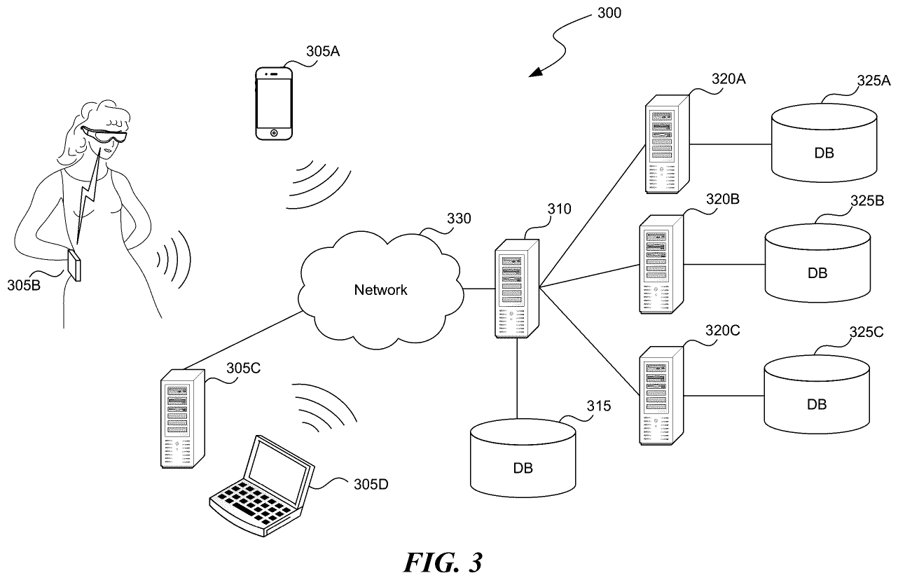

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

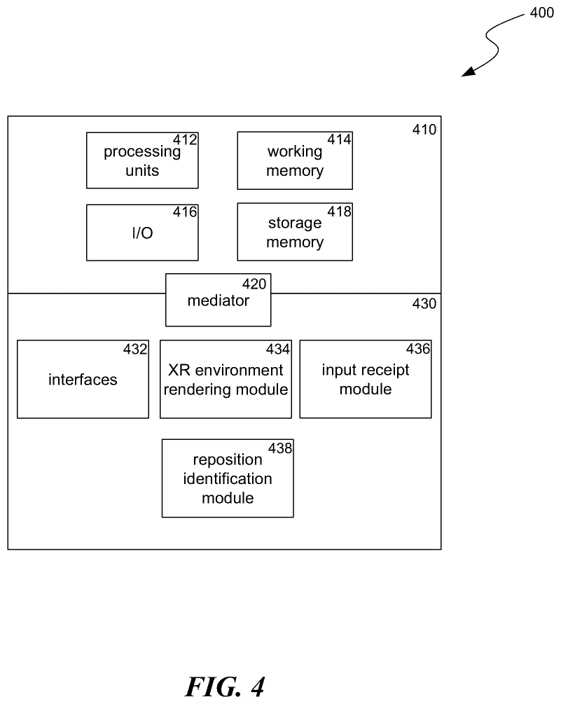

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for anchoring virtual objects to an anchor object in an artificial reality (XR) environment. Specialized components 430 can include XR environment rendering module 434, input receipt module 436, reposition identification module 438, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

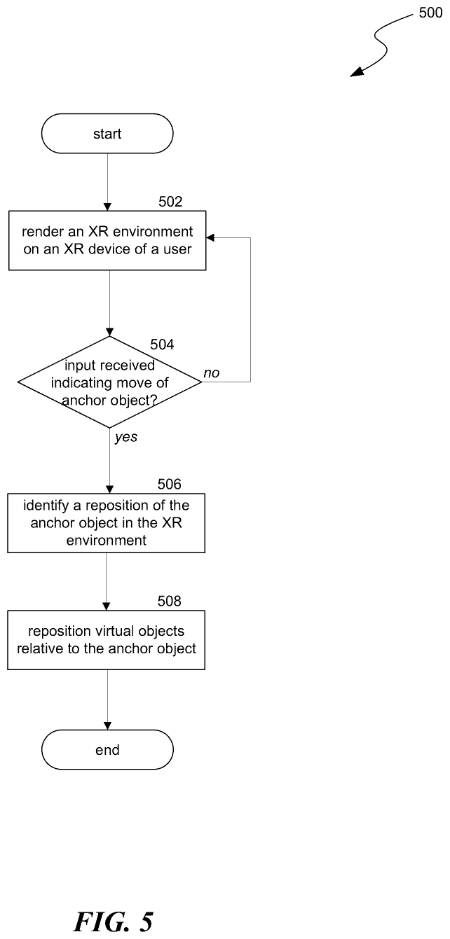

XR environment rendering module 434 can render an XR environment on an XR device of the user. The XR environment can include one or more virtual objects rendered relative to an anchor object. In some implementations, the anchor object can be a virtual object, e.g., a virtual menu for an XR application, a virtual gameboard for an XR game, etc. In some implementations, the anchor object can be a physical object, in the user's real-world environment, viewable while using the XR device (e.g., in pass-through). The anchor object can be manipulatable by the user (and other users accessing the XR environment, such as in a multiuser XR experience). Further details regarding rendering an XR environment on an XR device of a user are described herein with respect to block 502 of FIG. 5.

Input receipt module 436 can receive input indicating a move for the anchor object in the XR environment. The move can be on the x-, y-, and/or z-axis, and/or can include an orientational move (e.g., a pivot). In some cases, input receipt module 436 only registers the movement in certain directions, such as only pivots and/or only movement in the x/z (horizontal to the ground) plane. In some implementations, the input can be received via input/output devices 416. For example, the user can use a physical XR controller to select and manipulate the anchor object. In another example, the user can make a gesture with one or more hands to manipulate the anchor object (e.g., via a pinch and move of the hand), the gesture being detected and interpreted by the XR device (or another XR device in an XR system). In still another example, the user can control and manipulate the anchor object using gaze (e.g., dwelling on the anchor object for a threshold amount of time, moving the gaze to a new location, then dwelling on the new location), the gaze being detected and interpreted by the XR device (or another XR device in an XR system). Further details regarding receiving input indicating a move for an anchor object in an XR environment are described herein with respect to block 504 of FIG. 5.

Reposition identification module 438 can, based on the input received by input receipt module 436, identify a reposition of the anchor object in the XR environment. Reposition identification module 438 can identify the reposition based on the received input (or cessation thereof). For example, if the received input is a click-and-drag on a controller, reposition identification module 438 can identify the new position based on release of a physical button on the controller. In another example, if the received input is a pinch-and-drag gesture, reposition identification module 438 can identify the new location based on release of the pinch gesture, and/or based on performance of another gesture associated with identifying the new location (e.g., a push forward of the pinch gesture). In still another example, if the received input is a gaze dwell and movement of the gaze, reposition identification module 438 can identify the new position based on dwell of the gaze at a particular terminus for a threshold amount of time. Further details regarding identifying a reposition of an anchor object in an XR environment are described herein with respect to block 506 of FIG. 5.

Based on the reposition of the anchor object identified by reposition identification module 438, XR environment rendering module 434 can update rendering of the XR environment. For example, when the anchor object is a virtual anchor object, XR environment rendering module 434 can render the anchor object at the new location identified by reposition identification module 438. XR environment rendering module 434 can further, based on the repositioning of the anchor object, render corresponding repositioning of the one or more virtual objects relative to the anchor object on the XR device, such that relational positioning between the anchor object and the one or more virtual objects is maintained. Further details regarding updating rendering of an XR environment based on an identified reposition of an anchor object is described herein with respect to be block 508 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for anchoring virtual objects to an anchor object in an artificial reality (XR) environment. In some implementations, process 500 can be performed automatically as a response to activation or donning of an XR system. In some implementations, process 500 can be performed upon launch of one or more XR applications controlling the XR environment. In some implementations, process 500 can be performed by an XR system including one or more XR devices, such as an XR head-mounted display (HMD) (e.g., XR HMD 200 of FIG. 2A and/or XR HMD 252 of FIG. 2B), one or more controllers (e.g., controllers 276A and/or 276B of FIG. 2C) or other input devices, one or more separate processing components, etc. In some implementations, one or more steps of process 500 can be performed or facilitated by a remote computing system, such as a platform computing system, edge computing system, cloud computing system, etc. In some implementations, process 500 can be performed by anchor object management system 164 of FIG. 1 and/or specialized components 430 of FIG. 4.

At block 502, process 500 can render an XR environment on an XR device of a user. The XR environment can include one or more virtual objects rendered relative to an anchor object. The XR environment can be rendered from a perspective of the user of the XR device (i.e., the user wearing an XR HMD). In some implementations, the user can have a corresponding avatar in the XR environment viewable to other users accessing the XR environment, such as when the XR environment is a multi-user XR experience. In some implementations, the one or more virtual objects can include one or more avatars corresponding to other users accessing the XR environment via other XR devices.

In some implementations, the anchor object can be a virtual object rendered on the XR device and moveable in the XR environment. In some implementations, the anchor object can be static, e.g., having no animated features and/or having no functions other than moveability and display in the XR environment. In some implementations, the anchor object can be dynamic, e.g., having one or more animated features and/or having one or more functions other than moveability and display in the XR environment, such as an interactive menu allowing launch of XR applications and/or functions.

In some implementations, the anchor object can be a physical object in a real-world environment around the XR device and viewable while using the XR device. In some implementations, the anchor object can be a “stage device.” As used herein, a “stage device” can be a device separate from the XR device, but included in the XR system along with the XR device, and can be in operable communication with the XR device. The stage device can be, for example, a device obtaining and transmitting its pose and/or position to the XR system, such that virtual objects can be rendered relative to the stage device, as described further herein. In some implementations, the anchor object can be another physical object without electronic and/or communication capabilities with the XR device, whose pose and/or position can be tracked by the XR device using, e.g., computer vision techniques.

In some implementations, the anchor object can act as a moveable spatial anchor for the XR environment. Spatial anchors are world-locked frames of reference that can be created at particular positions and orientations to position content at consistent points in an XR experience, and can be created manually by a user or automatically by the XR system. Conventionally, spatial anchors can be persistent across different sessions of an XR experience, such that a user can stop and resume an XR experience, while still maintaining content at the same locations in the real-world environment relative to the spatial anchors. The anchor object, however, can be moveable, and thus can cause corresponding movement of virtual objects while executing an XR experience or when resuming an XR experience, as described further herein.

In some implementations, process 500 can render a fully immersive, computer-generated virtual reality (VR) experience relative to the anchor object. In some implementations, process 500 can render the VR experience with respect to the anchor object. In some implementations, process 500 can render the one or more virtual objects overlaid onto a view of the real-world environment surrounding the XR device, at positions in the real-world environment relative to the anchor object, such as in a mixed reality (MR) or augmented reality (AR) experience.

At block 504, process 500 can receive input indicating a move for the anchor object in the XR environment. In some implementations, when the anchor object is a stage device in the real-world environment, the input can be movement data, updated position data, and/or updated pose data captured by one or more sensors of the stage device (e.g., one or more sensors of an IMU). In some implementations, when the anchor object is another physical object in the real-world environment, the input can be captured movement data, updated position data, and/or updated pose data for the physical object captured by one or more cameras of the XR device.

In some implementations, when the anchor object is a virtual object, process 500 can receive input associated with or indicative of interaction with the anchor object from an input device, such as one or more handheld controllers (e.g., controller 276A and/or controller 276B of FIG. 2C) that allow the user to interact with the view of the anchor object presented by an XR device. The controllers can include various buttons and/or joysticks that a user can actuate to provide selection input and interact with the anchor object, such as by casting a ray into the XR environment controllable to select the anchor object, then moveable to move the anchor object.

When the anchor object is a virtual object, the input can be a gesture, by the user of the XR device, relative to the anchor object, as detected by the XR device, such as a pinch gesture on or within a threshold distance of the anchor object and a drag motion to a new location. Although described herein with particular exemplary gestures, it is contemplated that process 500 can identify any suitable gesture that can be associated with or indicative of an intention to interact with the anchor object. For example, process 500 can identify a pinch gesture, a tap gesture, a pointing gesture, a circling gesture, an underlining gesture, a movement in a particular direction, etc.

In some implementations, process 500 can detect the gesture via one or more cameras integral with or in operable communication with the XR device, such as cameras positioned on an XR HMD pointed away from the user's face. For example, process 500 can capture one or more images of the user's hand and/or fingers in front of the XR device while making a particular gesture. Process 500 can perform object recognition on the captured image(s) to identify a user's hand and/or fingers making a particular gesture (e.g., pointing, snapping, tapping, pinching, etc.). In some implementations, process 500 can use a machine learning model to identify the motion indicative of a gesture from the image(s). For example, process 500 can train a machine learning model with images capturing known gestures, such as images showing a user's hand making a fist, a user's finger pointing, a user making a sign with her fingers, a user placing her pointer finger and thumb together, etc. Process 500 can identify relevant features in the images, such as edges, curves, and/or colors indicative of fingers, a hand, etc., making a particular gesture. Process 500 can train a machine learning model using these relevant features of known gestures. Once the model is trained with sufficient data, process 500 can use the trained model to identify relevant features in newly captured image(s) and compare them to the features of known gestures. In some implementations, process 500 can use the trained model to assign a match score to the newly captured image(s), e.g., 80%. If the match score is above a threshold, e.g., 70%, process 500 can classify the motion captured by the image(s) as being indicative of a particular gesture. In some implementations, process 500 can further receive feedback from the user regarding whether the identification of the gesture was correct (e.g., by the user re-making the gesture, by the user returning the anchor object to its original location, or by the user leaving the anchor object at its new location), and update the trained model accordingly.

In some implementations, process 500 can determine or confirm a gesture by analyzing a waveform indicative of electrical activity of one or more muscles of the user using one or more wearable electromyography (EMG) sensors, such as on an EMG wristband in operable communication with the XR device. In some implementations, the EMG sensors can capture one or more motions indicative of one or more predefined gestures. For example, the one or more motions can include movement of a hand, movement of one or more fingers, etc., when at least one of the one or more EMG sensors is located on the hand and/or one or more fingers. Process 500 can analyze the waveform captured by one or more EMG sensors worn by the user by, for example, identifying features within the waveform and generating a signal vector indicative of the features. In some implementations, process 500 can compare the signal vector to known gesture vectors stored in a database to identify if any of the known gesture vectors matches the signal vector within a threshold, e.g., is within a threshold distance of a known threshold vector (e.g., the signal vector and a known gesture vector have an angle therebetween that is lower than a threshold angle). If a known gesture vector matches the signal vector within a threshold, process 500 can determine the gesture associated with the vector, e.g., from a look-up table.

In some implementations, process 500 can determine or confirm a gesture based on motion data collected from one or more sensors of an inertial measurement unit (IMU), integral with or in operable communication with the XR device (e.g., in a wearable device in communication with the XR device), to identify and/or confirm the one or more motions of the user. The measurements may include the non-gravitational acceleration of the device in the x, y, and z directions; the gravitational acceleration of the device in the x, y, and z directions; the yaw, roll, and pitch of the device; the derivatives of these measurements; the gravity difference angle of the device; and the difference in normed gravitational acceleration of the device. In some implementations, the movements of the device may be measured in intervals, e.g., over a period of 5 seconds.

For example, when motion data is captured by a gyroscope and/or accelerometer in an IMU (e.g., controller 276A and/or controller 276B of FIG. 2C), process 500 can analyze the motion data to identify features or patterns indicative of a particular gesture, as trained by a machine learning model. For example, process 500 can classify motion data captured by a controller or wearable device as a pinching motion based on characteristics of the device movements. Exemplary characteristics include changes in angle of the controller with respect to gravity, changes in acceleration of the controller, etc.

Alternatively or additionally, process 500 can classify the device movements as particular gestures based on a comparison of the device movements to stored movements that are known or confirmed to be associated with particular gestures. For example, process 500 can train a machine learning model with accelerometer and/or gyroscope data representative of known gestures, such as pointing, snapping, waving, pinching, tapping, holding up a certain number of fingers, clenching a fist, spreading the fingers, clicking, tapping, etc. Process 500 can identify relevant features in the data, such as a change in angle of a controller or wearable device within a particular range, separately or in conjunction with movement of the controller or wearable device within a particular range. When new input data is received, i.e., new motion data, process 500 can extract the relevant features from the new accelerometer and/or gyroscope data and compare it to the identified features of the known gestures of the trained model. In some implementations, process 500 can use the trained model to assign a match score to the new motion data, and classify the new motion data as indicative of a particular gesture if the match score is above a threshold, e.g., 75%. In some implementations, process 500 can further receive feedback from the user regarding whether an identified gesture is correct to further train the model used to classify motion data as indicative of particular gestures.

In some implementations, the input indicating a move for the anchor object in the XR environment can alternatively or additionally include user gaze input. In some implementations, process 500 can track the user gaze input via one or more cameras integral with or in operable communication with the XR device, such as cameras positioned on an XR device pointed toward the user's face. For example, process 500 can apply a light source directed to the user's eye which causes multiple reflections around the cornea that can be captured by a camera also directed at the eye. Images from the camera can be used by a machine learning model to estimate an eye position within the user's head. In some implementations, process 500 can also track the position of the user's head, e.g., using cameras that track the relative position of an XR device with respect to the world, and/or one or more sensors of an inertial measurement unit (IMU) in an XR HMD (e.g., IMU 215 of FIG. 2A), such as a gyroscope and/or compass. Process 500 can then model and map the eye position and head position of the user relative to the world to determine a vector representing the user's gaze through the XR HMD.

In some implementations, process 500 can detect a gaze dwell (e.g., a dwell selection) at a particular location (e.g., at an anchor object) for a predetermined period of time. For example, based on the user gaze input, the XR device can determine an eye gaze orientation that focuses or maintains a stationary terminus for a duration of time. For example, a user may focus her eye gaze at the anchor object. This pause and focus of gaze can act as a selection of the anchor object, which can then be moved by moving the gaze to a new location, and/or by making a gesture as described herein. Accordingly, in some implementations, process 500 can compare a length (e.g., duration) of the detected dwell to a time threshold.

A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the machine learning model can be a neural network with multiple input nodes that receive data about user gesture input and/or user gaze input. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer,) one or more nodes can produce a value classifying the input that, once the model is trained, can be interpreted as wave properties. In some implementations, such neural networks, known as deep neural networks, can have multiple layers of intermediate nodes with different configurations, can be a combination of models that receive different parts of the input and/or input from other parts of the deep neural network, or are convolutions or recurrent-partially using output from previous iterations of applying the model as further input to produce results for the current input.

A machine learning model can be trained with supervised learning, where the training data includes body member data (e.g., hand gesture data, eye gaze data, etc.) as input and a desired output, such as body member states. A representation of hand gesture input and/or gaze input can be provided to the model. Output from the model can be compared to the desired output for that hand gesture input and/or gaze input and, based on the comparison, the model can be modified, such as by changing weights between nodes of the neural network or parameters of the functions used at each node in the neural network (e.g., applying a loss function). After applying each of the hand gesture input and/or user gaze input in the training data and modifying the model in this manner, the model can be trained to evaluate new body member data. Similar training procedures can be used for the various machine learning models discussed above.

In some implementations, the input indicating a move for the anchor object can be an audible announcement by the user to move the anchor object to a new location in the XR environment identifiable by the XR device. The audible announcement can be captured by one or more microphones integral with or in operable communication with the XR device, then can be transcribed, parsed, and/or transformed into a command usable by the XR device. For example, the user can audibly request that the anchor object be moved by a particular distance (e.g., left 1 meter). In another example, the user can audibly request that the anchor object be moved relative to another virtual object (e.g., move the anchor object next to the virtual flower vase).

In still another example, the user can audibly request that the anchor object be moved relative to a physical object in the real-world environment (e.g., on a real-world table, on a real-world couch, etc.). In some implementations, process 500 can identify the stated physical object by applying computer vision, machine learning, and/or object recognition techniques. In some implementations, process 500 can identify the stated physical object from scene data previously established for the real-world environment. For example, the XR system can scan the real-world environment to specify object locations and types within a defined scene lexicon (e.g., desk, chair, wall, floor, ceiling, doorway, etc.). This scene identification can be performed, e.g., through a user manually identifying a location with a corresponding object type or with a camera to capture images of physical objects in the scene and use computer vision techniques to identify the physical objects as object types. In some implementations, the XR system can store the object types in relation to one or more spatial anchors defined for that area, and/or in relation to other localization data, such as mesh data, an XR space model, etc., as described further below.

At blocks 506, process 500 can, based on the received input, identify a reposition of the anchor object in the XR environment. In some implementations, the reposition of the anchor object can be in six degrees of freedom, sometimes only in one plane—e.g., horizontally to the ground, sometimes only rotationally in one or more planes, or combinations thereof. When the input is physical movement of a stage device, process 500 can identify the reposition of the anchor object based on sensor data captured by the stage device and transmitted to the XR device. When the input is physical movement of another physical object, process 500 can identify the reposition of the anchor object based on movement captured in one or more images by the XR device. Process 500 can analyze such images to determine an amount and direction of movement relative to one or more previously captured images of the anchor object.

When the input is a gesture, process 500 can determine a location at which the gesture is released, a location at which the gesture is terminated (e.g., the gesture lingers at a location for a threshold amount of time, the gesture stops movement, etc.), and/or the location that another gesture, associated with marking a location, is made. In another example, when the input is a gaze, process 500 can determine a location at which the gaze stops moving and dwells at a new location for a threshold amount of time. In still another example, when the input is a controller selection and movement, process 500 can determine a location at which a physical button is released or is reselected. When the input is an audible request by the user, process 500 can determine a new location for the anchor object as designated or specified by the request, and as described above.

In some implementations, in identifying the reposition of the anchor object, process 500 can “snap” the anchor object to a physical object in the real-world environment, such as a table, a wall, a floor, etc., when the requested position of the anchor object is proximate to (i.e., within a threshold distance of) the physical object. In some implementations, process 500 can identify a physical object within the threshold distance of the requested position via scene data specifying object types and locations, as described further above, and reposition the anchor object overlaid onto or positioned proximate to (e.g., on top of, on a side of, on the bottom of) the physical object.

In some implementations, process 500 can “snap” the anchor object to a proximate portion of an XR space model (referred to in some cases as a “room box”) established for the real-world environment, which, in some implementations, can further include scene data. An XR space model (referred to interchangeably herein as a “room box”) can indicate where the walls, floor, and ceiling exist the real-world space. In some implementations, process 500 can obtain the XR space model automatically. For example, a user of an XR device can scan the real-world space using one or more cameras and/or one or more depth sensors by moving and/or looking around the real-world space with the XR device, and automatically identify one or more flat surfaces (e.g., walls, floor ceiling) in the real-world space using such image and/or depth data. For example, process 500 can identify the flat surfaces by analyzing the image and/or depth data for large areas of the same color, of consistently increasing and/or decreasing depth relative to the XR device, and/or of particular orientations (e.g., above, below, or around the XR device), etc. Further details regarding generating and using XR space models are described in U.S. patent application Ser. No. 18/346,379, filed Jul. 3, 2023, entitled “Artificial Reality Room Capture Realignment” (Attorney Docket No. 3589-0262US01), which is herein incorporated by reference in its entirety.

In some implementations, process 500 can “snap” the anchor object to a proximate portion of a mesh established for the real-world environment that was generated by scanning the real-world environment with the XR device. The mesh can be, for example, a three-dimensional (3D) model of the boundaries of the real-world space, including one or more walls, the ceiling, the floor, one or more physical objects, etc. In some implementations, process 500 can generate the mesh using one or more cameras, one or more depth sensors, or any combination thereof. Further details regarding generating and using XR space models and meshes are described in U.S. patent application Ser. No. 18/454,349, filed Aug. 23, 2023, entitled “Assisted Scene Capture for an Artificial Reality Environment” (Attorney Docket No. 3589-0286US01), which is herein incorporated by reference in its entirety. Similarly, in some implementations, process 500 can “snap” the anchor object to a virtual object proximate to (i.e., within a threshold distance of) the requested location of the anchor object in the XR environment, with the virtual object's location known to the XR device.

Reposition of the anchor object in the XR environment can cause corresponding repositioning of the one or more virtual objects relative to the anchor object on the XR device at block 508, such that relational positioning between the anchor object and the one or more virtual objects is maintained. The anchor object can be moveable in one or more of any directions, including in an x-axis direction, y-axis direction, z-axis direction, and/or rotationally. For example, process 500 can determine an amount of orientation and/or position change of the anchor object, and reposition the virtual objects with a corresponding amount of orientation and/or position change. For example, if the anchor object is rotated to the left 45 degrees, process 500 can rotate the virtual objects to the left 45 degrees correspondingly. In another example, if the anchor object is moved 1 meter to the right, process 500 can shift the virtual objects 1 meter to the right correspondingly. Thus, the anchor object and the virtual objects maintain their relative orientations and positions, including their separation distances.

In a multi-user XR environment, process 500 can cause corresponding repositioning of other avatar(s) accessing the XR environment relative to the anchor object, as rendered on the user's XR device, such that relational positioning between the anchor object and the other avatar(s) is maintained. However, based on the received input identifying the reposition of the anchor object in the XR environment by the user's XR devices, the other XR device(s) accessing the XR environment can render the avatar of the user moving reciprocally relative to the anchor object, and, in some implementations, without rendering movement of the anchor object. In other words, as rendered on the other XR device(s), relational positioning of the user's avatar and the anchor object is changed, while relational positioning between the other avatar(s) and the anchor object is maintained, as rendered on their respective XR device(s).

In this sense, the virtual objects can be considered “locked” to the anchor object in the XR environment, as opposed to being “head-locked” (i.e., tied to movement of the head of the user) or “world-locked” (i.e., locked to the real-world environment, regardless of movement of the XR device). In some implementations, however, it is contemplated that some virtual objects may be locked to the anchor object, while others can be head-locked and/or world-locked, as specified by the user, by the XR system, and/or by an XR application executing on the XR system and managing one or more virtual objects rendered in the XR environment.

Thus, according to some implementations provided herein, process 500 can provide continuity and consistency for multiple users accessing an XR environment. By moving virtual objects along with the anchor object as rendered on a user's XR device, and correspondingly moving the user's avatar in the XR environment (and, in some implementations, without movement of the anchor object) as rendered on other users' XR device, some implementations provide for consistent mapping of objects in three-dimensional space. For example, the user can point to a virtual object as rendered on the user's XR device, and other users will see the user pointing at the same virtual object, despite the user's movement of the anchor object. Further, by allowing movement of the anchor object (and corresponding movement of virtual objects), the user experience is improved by allowing users to move the anchor object to reach and interact with virtual objects otherwise out of reach.

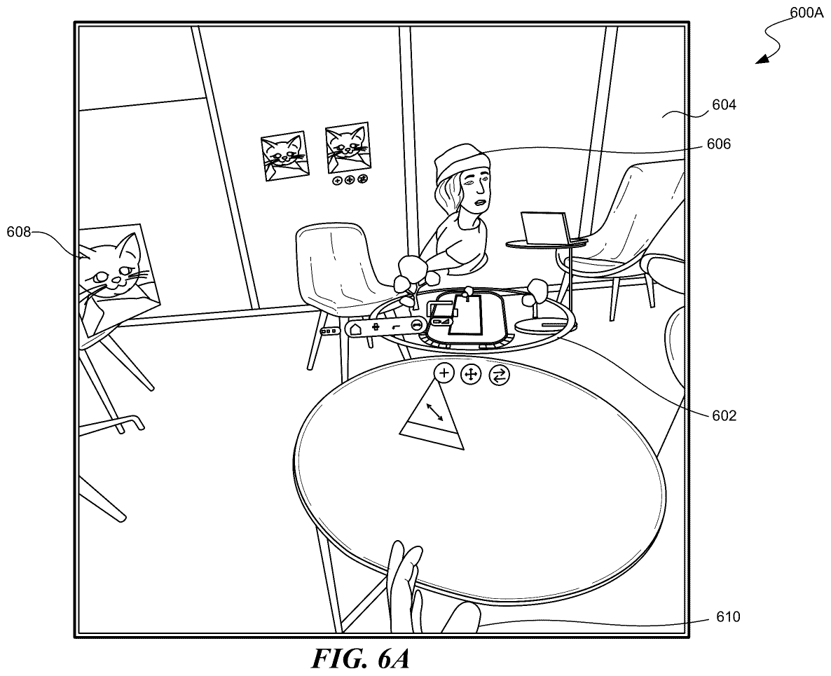

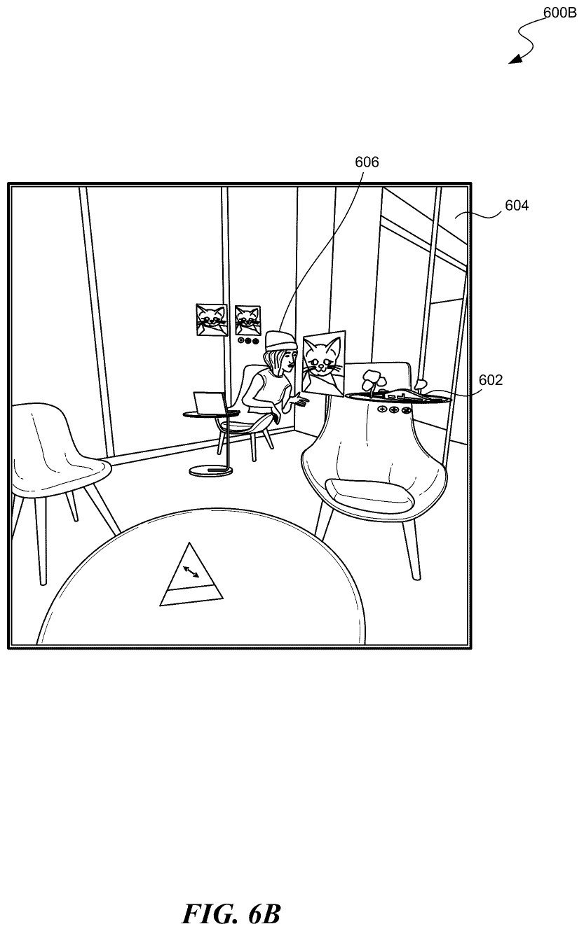

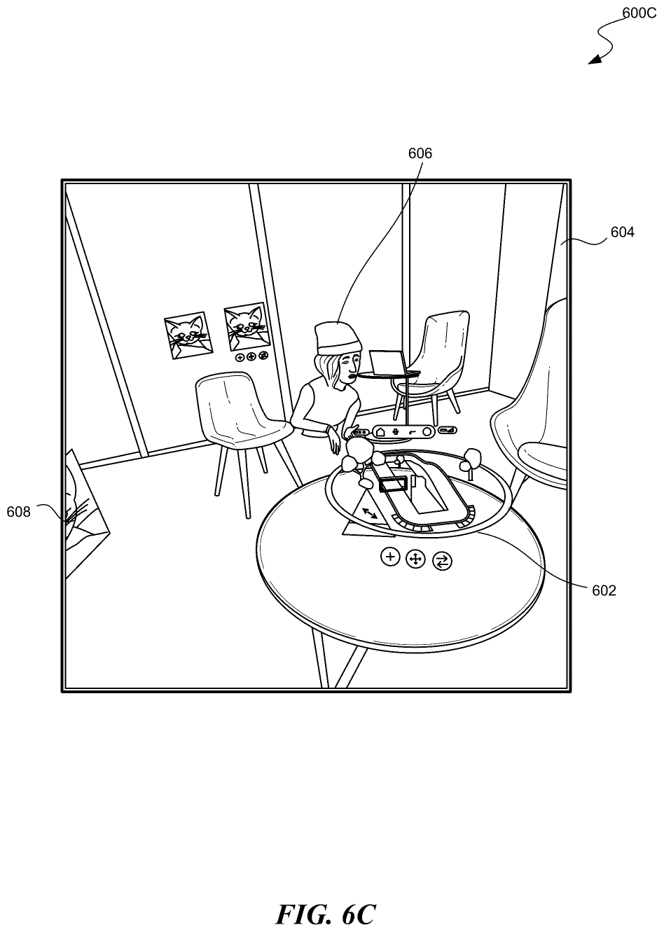

FIG. 6A is a conceptual diagram illustrating an example view 600A on an artificial reality (XR) system of a virtual anchor object 602 that can be used to provide spatial consistency for multiple users in a shared XR environment 604. View 600A can be from the perspective of a user, on an XR device, having avatar 610. All avatars (e.g., avatar 606) and virtual objects (e.g., virtual object 608) can be fixed relative to virtual anchor object 602, and virtual anchor object 602 can be moveable and rotatable in XR environment 604. Thus, the user (having avatar 610) can select the location of virtual anchor object 602 in XR environment 604, and, correspondingly, the location of the avatars (e.g., avatar 606) and virtual objects (e.g., virtual object 608) in XR environment 604. In this view 600A, virtual anchor object 602 can be a white ring to which virtual objects both inside and outside are locked.

FIGS. 6B and 6C are conceptual diagrams illustrating example views 600B-C from an XR device of a user (represented by avatar 610 shown in view 600A of FIG. 6A) when the user's avatar 610 both moves toward and moves an anchor object 602. As avatar 610 moves toward anchor object 602, the other user accessing XR environment 604 (associated with avatar 606) will see avatar 610 approach anchor object 602. As avatar 610 moves clockwise around anchor object 602, the other user will correspondingly see the avatar 610 move clockwise around anchor object 602.

As the user moves anchor object 602 (e.g., by selecting and dragging anchor object 602), all XR content (including, e.g., avatar 606 and virtual object 608) will move with anchor object 602, such that the XR content maintains relative positions with anchor object 602, as rendered on the user's XR device, and as shown in view 600C of FIG. 6C. Assuming no movement or manipulation of anchor object 602 on the part of other users, the other users (e.g., the user associated with avatar 606) will see the shared XR content maintain their relative positions to anchor object 602, and anchor object 602 maintaining its location, but will see avatar 610 move relative to anchor object 602.

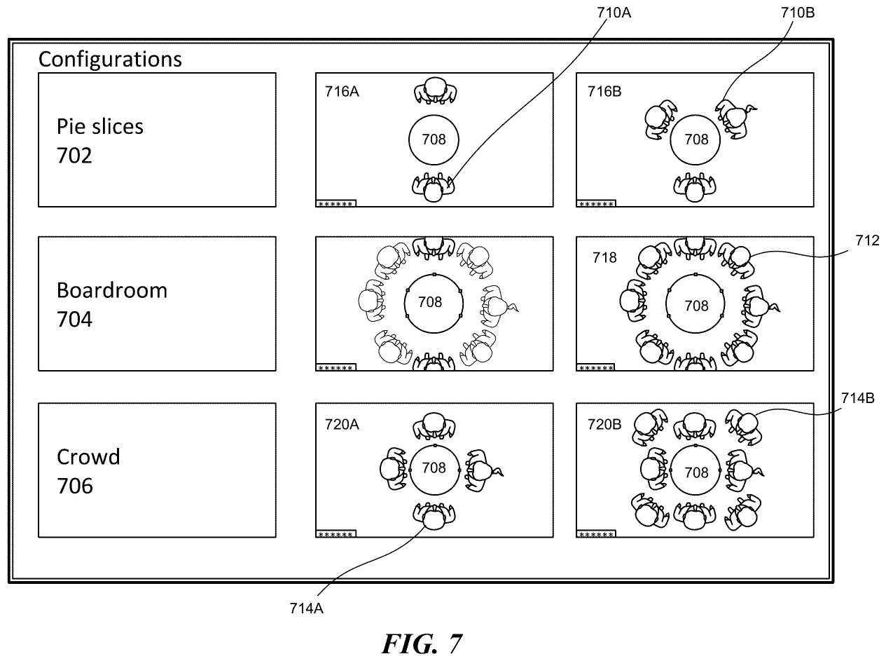

FIG. 7 is a conceptual diagram illustrating example positionings of avatars (e.g., 710A-710B, 712, 714A-714B) around an anchor object 708. XR content, such as avatars (e.g., 710A-710B, 712, 714A-714B) and/or other virtual objects, can appear in different orientations in a circle around anchor object 708, and, in some implementations, can be automatically positioned around anchor object 708 according to various configurations 702-706. For example, in configuration 702, avatars can be positioned around anchor object 708 as if anchor object 708 were split into pie slices equally based on the number of users, such as shown in examples 716A-716B. In example 716A, for two avatars (including, e.g., avatar 710A), the avatars can appear directly across anchor object 708 from each other, as if anchor object 708 were split into two pie slices. In example 716B, for three avatars (including, e.g., avatar 710B), the avatars can appear at three equidistant points around anchor object 708, as if anchor object 708 were split into three pie slices.

In configuration 704, avatars (including, e.g., avatar 712) can all be positioned around anchor object 708, such that they appear at seats around anchor object 708 (which can be, for example, a virtual conference table), as shown in example 718. In some implementations, as the number of avatars around anchor object 708 grows, anchor object 708 can become bigger to accommodate the larger number of avatars, and/or the avatars can be moved further from anchor object 708 to accommodate the larger number of avatars in front of anchor object 708.

In configuration 706, avatars can be positioned as a crowd around anchor object 708. In example 720A in which only a few avatars (including, e.g., avatar 714A) are around anchor object 708, the avatars can each be positioned at equidistant locations around anchor object 708, such as in pie slice configuration 702. However, as the number of avatars (including, e.g., avatar 714B) increases, the avatars can be staggered around anchor object 708 such that some avatars are standing behind others and have varying distances from anchor object 708. Crowd configuration 706 can be differentiated from boardroom configuration 704, in that anchor object 708 is not made larger to accommodate the larger number of avatars, and/or the avatars are not positioned with equidistance from anchor object 708. Further details regarding avatar configurations and placement in an XR environment are described in U.S. patent application Ser. No. 18/473,648, filed Sep. 25, 2023, entitled, “Augmented Call Spawn Configuration for Digital Human Representations in an Artificial Reality Environment” (Attorney Docket No. 3589-0267US01), which is herein incorporated by reference in its entirety.

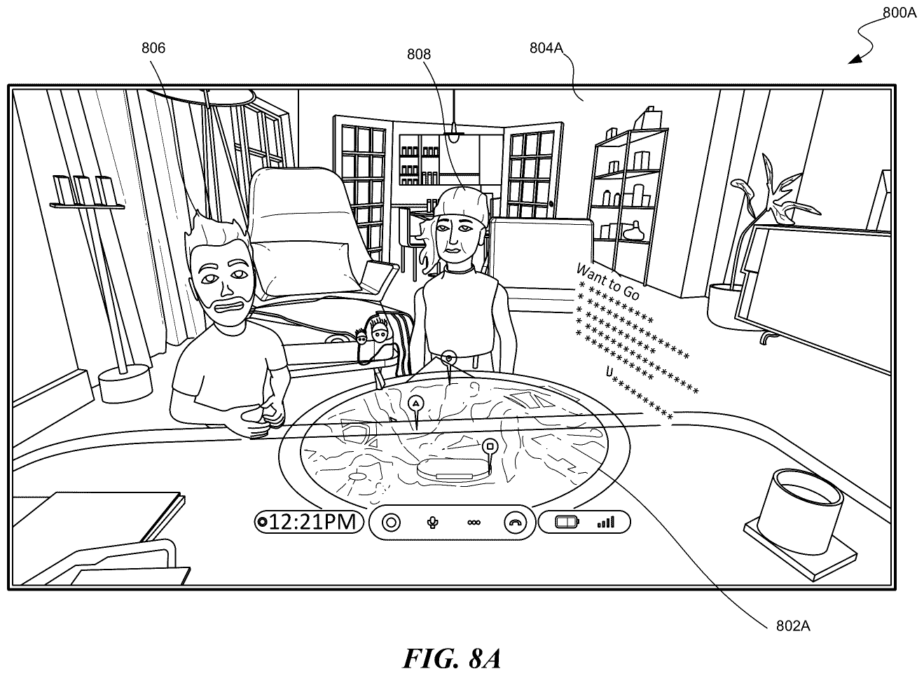

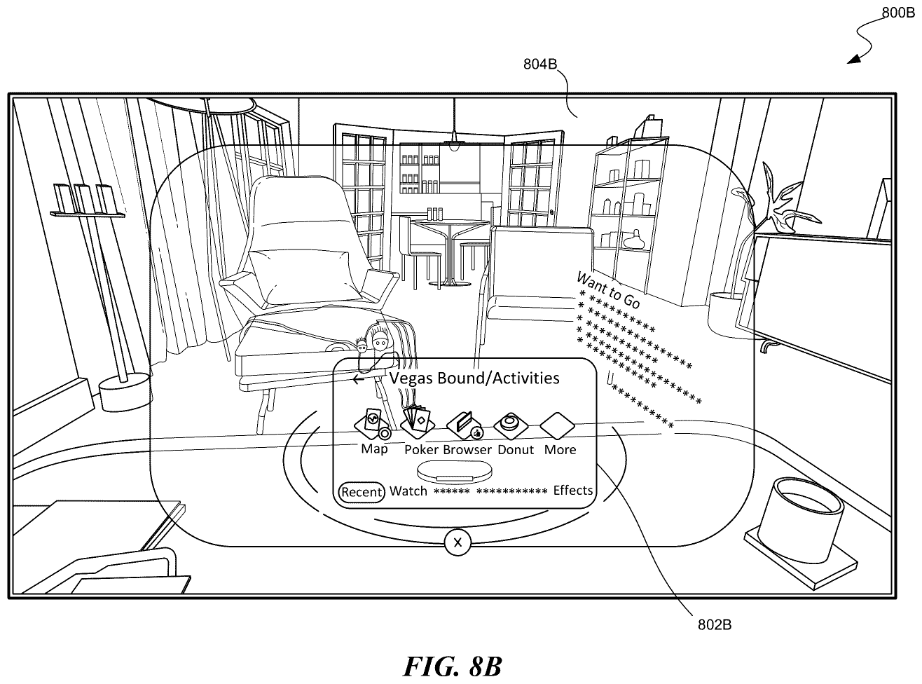

FIGS. 8A and 8B are conceptual diagrams illustrating exemplary views 800A-800B, on an XR device, of XR environments 804A-804B including dynamic anchor objects 802A-802B that can launch and execute XR applications. For example, XR environment 804A of FIG. 8A can include an XR boardgame experience in which anchor object 802A can execute, launch, and act as the augmented gameboard for the users accessing the XR experience (e.g., the user having view 800A, the user represented by avatar 806, and the user represented by avatar 808). In another example, anchor object 802B of FIG. 8B can execute, launch, and act as a menu to explore a destination, with various available functionalities associated with the destination.

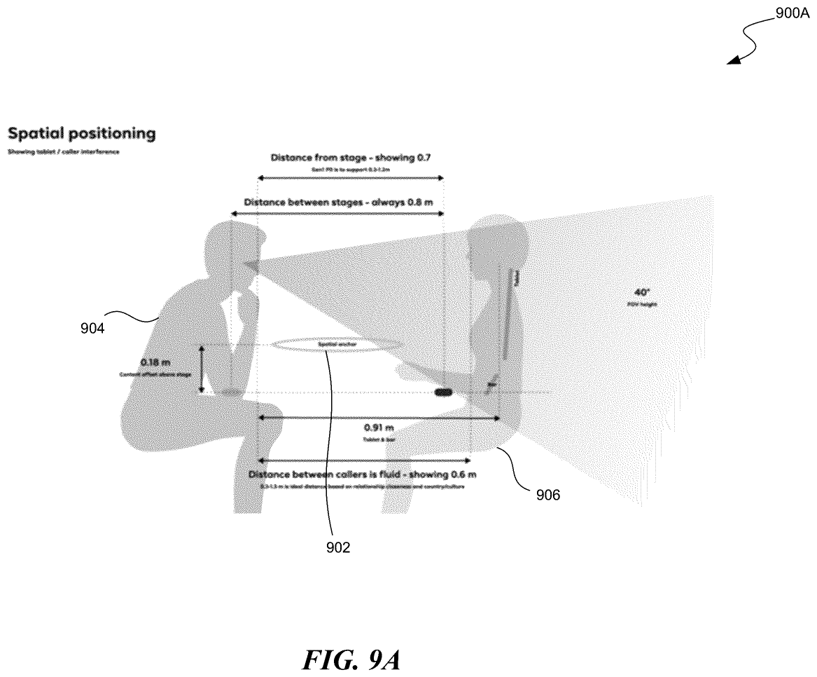

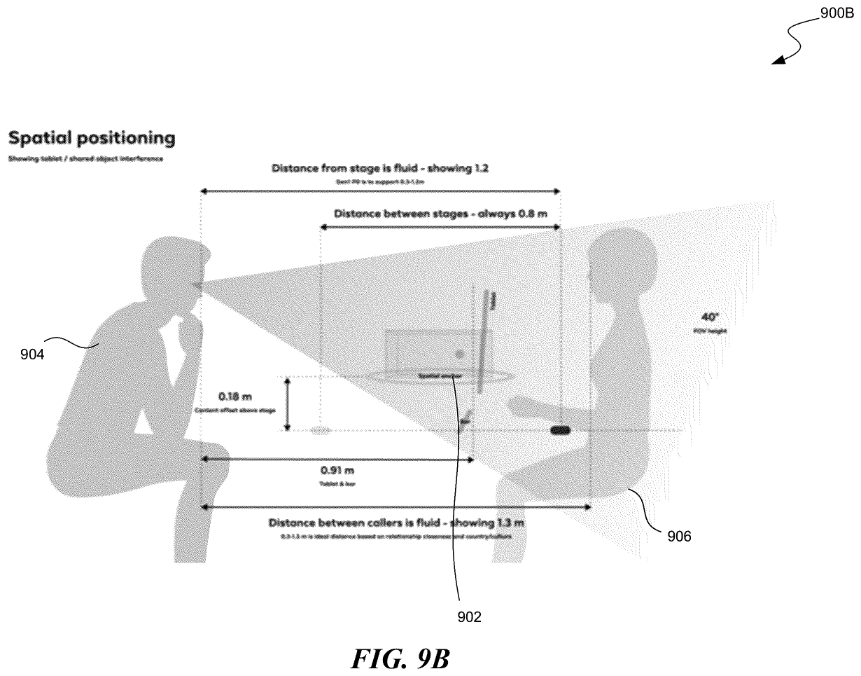

FIGS. 9A and 9B are conceptual diagrams illustrating exemplary views 900A-900B of spatial distance positioning between two avatars 904-906 in an XR environment relative to an anchor object 902. Anchor object 902 can appear as a ring or other virtual object on the users' XR devices. Anchor object 902 can be manipulated to translate (x, y, z) and/or rotate (p, q, r) the XR environment, allowing full control of the frame of reference with up to six-degrees of freedom. For example, anchor object 902 can be raised or lowered, e.g., placed on top of a physical coffee table in user 904's real-world environment. Anchor object 902 may be rotated to move XR objects. In some implementations, the anchor object management system described herein can analyze both users' (corresponding to avatars 904-906) real-world environments and automatically place both avatars 904-906 so they are at eye level and not conflicting with each other's real-world environment.

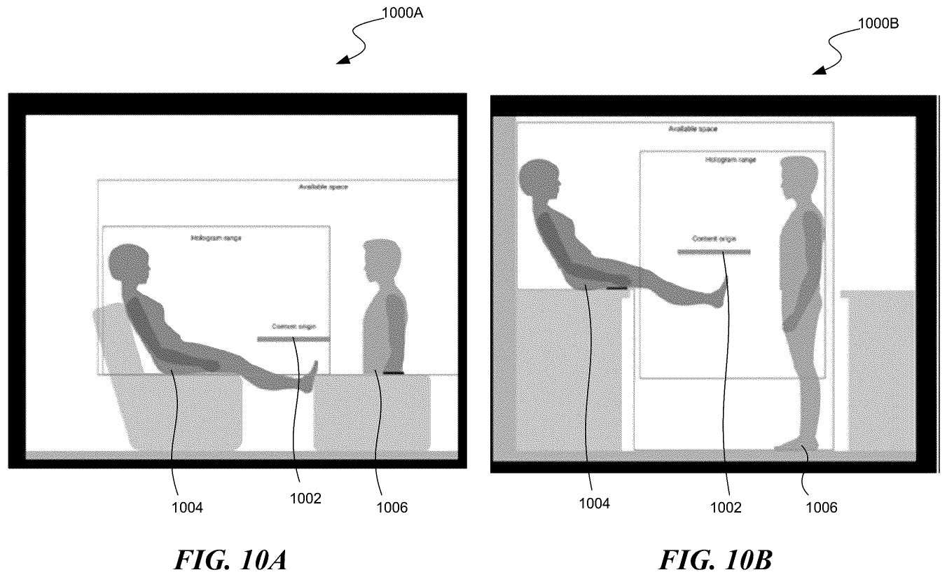

FIGS. 10A and 10B are conceptual diagrams illustrating exemplary views 1000A-1000B of vertical positioning of two avatars 1004, 1006 in an XR environment relative to an anchor object 1002. In some implementations, regardless of the height and positioning (e.g., standing or sitting) of the users associated with avatars 1004-1006, avatars 1004-1006 can appear at eye level with each other. For example, in view 1000A, when the user associated with avatar 1004 is sitting in a chair and the user associated with avatar 1006 is standing, avatar 1006 can be lowered to the eye level of avatar 1004. In view 1000B, when the user associated with avatar 1004 is sitting on a high countertop and the user associated with 1006 is standing, avatar 1006 can be rendered as standing at the eye level of avatar 1006.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative mutually implementations exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for manipulating an artificial reality environment by anchoring virtual objects to an anchor object in the artificial reality environment, the method comprising:
rendering the artificial reality environment on an artificial reality device of a user,
wherein the artificial reality environment includes one or more virtual objects rendered relative to the anchor object, the anchor object being moveable in the artificial reality environment;
receiving input indicating a move for the anchor object in the artificial reality environment; and
based on the received input, identifying a reposition of the anchor object in the artificial reality environment,
wherein reposition of the anchor object in the artificial reality environment causes corresponding repositioning of the one or more virtual objects relative to the anchor object on the artificial reality device, such that relational positioning between the anchor object and the one or more virtual objects is maintained.

2. The method of claim 1,
wherein the artificial reality environment is rendered from a perspective of the user relative to a position of an avatar of the user in the artificial reality environment.

3. The method of claim 2,
wherein the one or more virtual objects include an other avatar of an other user accessing the artificial reality environment via an other artificial reality device.

4. The method of claim 3, wherein, based on the received input identifying the reposition of the anchor object in the artificial reality environment on the artificial reality device, the other artificial reality device renders the avatar of the user moving reciprocally relative to the anchor object, such that relational positioning of the avatar and the anchor object is changed, while relational positioning between the other avatar and the anchor object is maintained.

5. The method of claim 1, wherein rotational movement of the anchor object causes corresponding rotational movement of the one or more virtual objects.

6. The method of claim 1, wherein the one or more virtual objects are one or more first virtual objects, and wherein the anchor object is a second virtual object rendered on the artificial reality device.

7. The method of claim 1, wherein the anchor object is a physical object in a real-world environment surrounding the artificial reality device.

8. The method of claim 7, wherein the anchor object is a stage device in operable communication with the artificial reality device and the stage device is configured to track its position relative to the artificial reality device.

9. The method of claim 7, wherein the artificial reality device is configured to track a position of the anchor object in the real-world environment.

10. A computer-readable storage medium storing instructions that, when executed by a computing system, cause the computing system to perform a process for manipulating an artificial reality environment by anchoring virtual objects to an anchor object in the artificial reality environment, the process comprising:
rendering the artificial reality environment on an artificial reality device of a user,
wherein the artificial reality environment includes one or more virtual objects rendered relative to the anchor object, the anchor object being moveable in the artificial reality environment;
receiving input indicating a move for the anchor object in the artificial reality environment; and
based on the received input, identifying a reposition of the anchor object in the artificial reality environment,
wherein reposition of the anchor object in the artificial reality environment causes corresponding repositioning of the one or more virtual objects relative to the anchor object on the artificial reality device, such that relational positioning between the anchor object and the one or more virtual objects is maintained.

11. The computer-readable storage medium of claim 10,
wherein the artificial reality environment is rendered from a perspective of the user relative to a position of an avatar of the user in the artificial reality environment.

12. The computer-readable storage medium of claim 11,
wherein the one or more virtual objects include an other avatar of an other user accessing the artificial reality environment via an other artificial reality device.

13. The computer-readable storage medium of claim 12, wherein, based on the received input identifying the reposition of the anchor object in the artificial reality environment on the artificial reality device, the other artificial reality device renders the avatar of the user moving reciprocally relative to the anchor object, such that relational positioning of the avatar and the anchor object is changed, while relational positioning between the other avatar and the anchor object is maintained.

14. The computer-readable storage medium of claim 10, wherein rotational movement of the anchor object causes corresponding rotational movement of the one or more virtual objects.

15. The computer-readable storage medium of claim 10, wherein the one or more virtual objects are one or more first virtual objects, and wherein the anchor object is a second virtual object rendered on the artificial reality device.

16. A computing system for manipulating an artificial reality environment by anchoring virtual objects to an anchor object in the artificial reality environment, the computing system comprising:
one or more processors; and
one or more memories storing instructions that, when executed by the one or more processors, cause the computing system to perform a process comprising:
rendering the artificial reality environment on an artificial reality device of a user,
wherein the artificial reality environment includes one or more virtual objects rendered relative to the anchor object, the anchor object being moveable in the artificial reality environment;
receiving input indicating a move for the anchor object in the artificial reality environment; and
based on the received input, identifying a reposition of the anchor object in the artificial reality environment,
wherein reposition of the anchor object in the artificial reality environment causes corresponding repositioning of the one or more virtual objects relative to the anchor object on the artificial reality device, such that relational positioning between the anchor object and the one or more virtual objects is maintained.

17. The computing system of claim 16, wherein the anchor object is a physical object in a real-world environment surrounding the artificial reality device.

18. The computing system of claim 17, wherein the anchor object is a stage device in operable communication with the artificial reality device and configured to track its position relative to the artificial reality device.

19. The computing system of claim 17, wherein the artificial reality device is configured to track a position of the anchor object in the real-world environment.

20. The computing system of claim 16,
wherein the artificial reality environment is rendered from a perspective of the user relative to a position of an avatar of the user in the artificial reality environment,
wherein the one or more virtual objects include an other avatar of an other user accessing the artificial reality environment via an other artificial reality device, and
wherein, based on the received input identifying the reposition of the anchor object in the artificial reality environment on the artificial reality device, the other artificial reality device renders the avatar of the user moving reciprocally relative to the anchor object, such that relational positioning of the avatar and the anchor object is changed, while relational positioning between the other avatar and the anchor object is maintained.
